(19) United States
(12) Patent Application Publication
(10) Pub. No.: US 2006/0239280 A1
(43) Pub. Date: Oct. 26, 2006

(54) Method and apparatus to facilitate point-to-point protocol renegotiation

(75) Inventors: Chandra Warrier, Schaumburg, IL (US); Michael Borella, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 11/184,750

(22) Filed: Jul. 19, 2005

Related U.S. Application Data
(60) Provisional application No. 60/674,855, filed on Apr. 26, 2005.

(51) Int. Cl. H04L 12/56

(52) U.S. Cl. 370/401

(57) ABSTRACT

When a network element detects (100) Point-to-Point Protocol renegotiation as corresponds to a client node, that network element then automatically accesses (102) context information as pertains to a previous Point-to-Point Protocol session for that client node. The network element then facilitates (103) that Point-to-Point Protocol renegotiation and determines (104) freshly presently context information as corresponds to that client node. These teachings then contemplate comparing (105) at least some of the freshly presented context information with the access context information to provide a comparison result. When this comparison result (106) corresponds to a least a first category of result (for example, when the comparison comprises a match between these corresponding categories of information) the network element then automatically processes (107) a registration as corresponds to the client node without also requesting revocation of a previously established registration state for the client node.

### RELATED APPLICATION

This application claims the benefit of U.S. Provisional Application No. 60/674,855 entitled Optimized Context Re-Use for Registration Revocation as was filed on Apr. 26, 2005 and bearing Attorney's Docket Number 7793/85329, the contents of which are fully incorporated herein by this reference.

### TECHNICAL FIELD

This invention relates generally to Point-to-Point Protocol (PPP) renegotiation as corresponds to a client node.

### BACKGROUND

Point-to-Point Protocol(s) serves to facilitate various kinds of communication sessions. Point-to-Point Protocol may be used to effect registration of a client node (such as a mobile node) with a Home Agent via a network element such as, but not limited to, a Packet Data Serving Node (where, for example, the client node specifically uses Point-to-Point Protocol between itself and the Packet Data Serving Node and Mobile Internet Protocol as between itself, the Packet Data Serving Node, and the Home Agent). As such registration corresponds to usage of ultimately limited network resources, registration revocation procedures are also typically supported. For example, when a communication session such as a Mobile Internet Protocol session is disconnected from a given network or is handed off between different network elements, the relevant Packet Data Serving Node and Home Agent will typically exchange registration revocation messages to ensure that there are no so-called dangling resources in the network.

Such registration revocation procedures, in fact, serve an important purpose. Unfortunately, however, presently existing ruthless application of such registration revocation procedures can; under some circumstances, lead to an arguably worsened state of resource usage rather than an improved state. For example, a client node can seek (for any number of reasons) to renegotiate a Point-to-Point Protocol session during which the client node presents a same home Internet Protocol address and/or a same Home Agent address pair as was previously presented. When this occurs, the serving network element (such as a Packet Data Serving Node) may blindly perform a registration revocation as corresponds to the earlier negotiated session. This, in turn, typically requires the serving node to delay registration procedures with respect to the Point-to-Point Protocol renegotiation until this revocation process has concluded.

### BRIEF DESCRIPTION OF THE DRAWINGS

The above needs are at least partially met through provision of the method and apparatus to facilitate Point-to-Point Protocol renegotiation described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a block diagram as configured in accordance with various embodiments of the invention;

FIG. 4 comprises a call flow diagram as configured in accordance with various embodiments of the invention;

FIG. 5 comprises a call flow diagram as configured in accordance with various embodiments of the invention;

FIG. 6 comprises a call flow diagram as configured in accordance with various embodiments of the invention; and

FIG. 7 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, when a network element detects Point-to-Point Protocol renegotiation as corresponds to a client node, that network element may automatically access context information as pertains to a previous Point-to-Point Protocol session for that client node. The network element then facilitates that Point-to-Point Protocol renegotiation and determines freshly presently context information as corresponds to that client node (which may be presented, for example, during a Mobile Internet Protocol registration). These teachings then contemplate comparing at least some of the freshly presented context information with the previous context information to provide a comparison result. When this comparison result corresponds to a least a first category of result (for example, when the comparison comprises a match between these corresponding categories of information) the network element then automatically processes a registration as corresponds to the client node without also requesting revocation of a previously established registration state for the client node.

In a preferred though not required approach, these teachings further contemplate automatically storing context information as pertains to the previous Point-to-Point Protocol and corresponding Mobile Internet Protocol session in response to detecting the Point-to-Point renegotiation to thereby render that previous state information available to be accessed as described. The context information itself can be whatever information is relevant and appropriate to a given application setting (which will of course potentially vary from setting to setting) but may comprise, for example, a home Internet Protocol address, a Home Agent address, and so forth.

So configured, a registration revocation process that would otherwise be automatically processed is avoided when certain conditions are met. In particular, registration revocation is preferably avoided when such revocation serves no particular useful purpose and will otherwise simply consume resources (bandwidth, time, or the like) that may be better applied. Those skilled in the art will appreciate that these teachings can be readily and economically deployed in an existing network without requiring much in the way of re-programming. For example, at least by one approach, neither Home Agents nor client nodes require any alteration with respect to their present functionality to nevertheless gain the benefits of this approach.

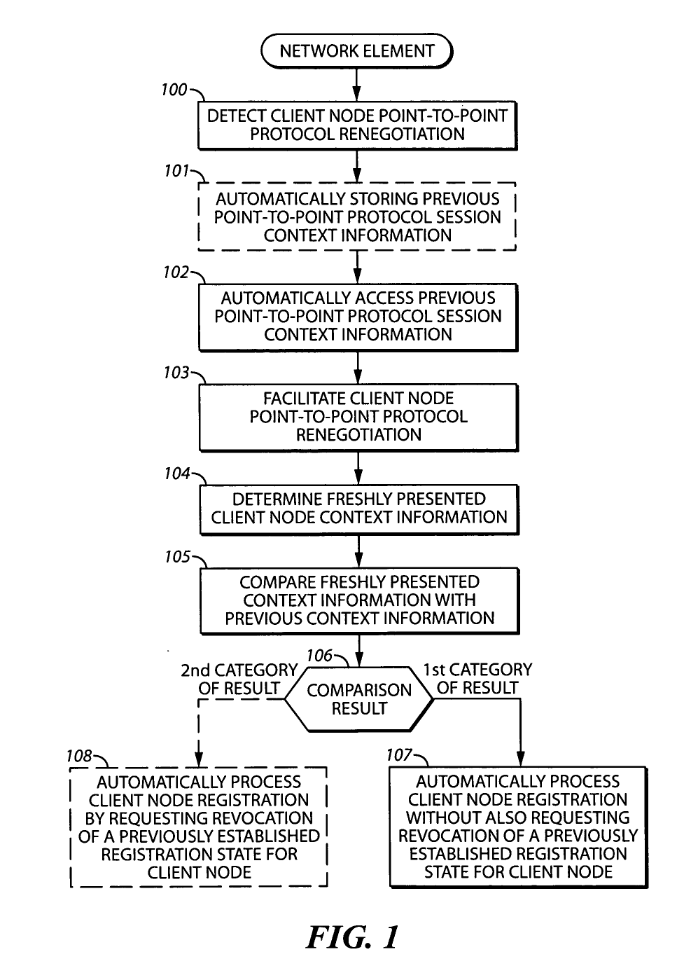

These and other benefits may become clearer upon making a thorough review and study of the following detailed description. Referring now to the drawings, and in particular to FIG. 1, the following teachings can be implemented in various ways. Pursuant to a preferred approach, these steps are implemented using a network element as comprises a part of a packet-based communication network (such as, but not limited to, a Packet Data Serving Node as is known in the art).

Pursuant to a preferred approach, this network element detects 100 a Point-to-Point Protocol renegotiation as corresponds to a given client node. The basis of this detection can and will vary with the specifics of a given communication network but may comprise, for example, processing a client node-sourced communication such as a Link Control Protocol configuration request and/or an Internet Protocol Control Protocol configuration request as are known in the art.

In a preferred though optional step, the network elements then automatically stores 101 context information as pertains to a previous Point-to-Point Protocol and Mobile Internet Protocol session for that client node. This can comprise, for example, storing present already-existing context information as was previously developed for that client node. The particular elements stored will of course also likely vary from application to application setting but may comprise, in an exemplary embodiment, context information regarding a specific Home Internet Protocol address as corresponds to the client node, a Home Agent address as corresponds to the client node, and so forth.

In any event, this process then provides for responding to detection of the Point-to-Point Protocol renegotiation by automatically accessing 102 context information as pertains to the previous Point-to-Point Protocol session to thereby provide accessed context information. This step can comprise, for example, accessing information as have been previously stored by the network element itself as is optionally suggested above or can comprise accessing such information via one or more other servers as may be provided for this or other purposes in a given communication network. The particular context information so accessed may again vary with the particulars of a given application setting but may comprise, for example, a Home Internet Protocol address and/or a Home Agent address.

This process then provides for facilitating 103 the Point-to-Point Protocol renegotiation with that client node. In particular, this process provides for determining 104 freshly presented context information as corresponds to the client node. This can comprise, for example, receiving, preferably during mobile Internet Protocol registration, fresh context information (such as a freshly presented Home Internet Protocol address and/or a Home Agent address as corresponds to the client node) from the client node pursuant to the Point-to-Point Protocol renegotiation process. The network element then, pursuant to a preferred approach, compares 105 at least some of the freshly presented context information with the accessed context information to provide a comparison result.

This process then determines 106 when this comparison result comprises a first category of result. This first category of result can comprise, for example, a match (or a substantial match) between corresponding categories of information. To illustrate, when the context information of interest comprises both a Home Internet Protocol address and a Home Agent address, the first category of result may correspond to when the freshly presented Home Internet Protocol address and the freshly presented Home Agent address match the accessed (and hence, the previous context information) for this client node.

When this comparison results corresponds to the predetermined first category of result, and as per a preferred approach, this process then provides for automatically processing 107 a registration as corresponds to the client node without also requesting revocation of the previously established registration state for the client node. This, in turn, will frequently result in a satisfactory renegotiation process that concludes in a more timely manner and via use of fewer overall system resources than present practices will typically otherwise provide.

In a preferred though optional approach, this process can also accommodate a scenario where the comparison result is determined to comprise a second category of result that is different from the first category of result. For example, the second category of result can comprise a mis-match for at least one entry of the context information for at least one corresponding category of information. In this case, for example, the process can provide for automatically processing 108 a registration as corresponds to the client node, at least in part, by requesting revocation of a previously established registration state for the client node.

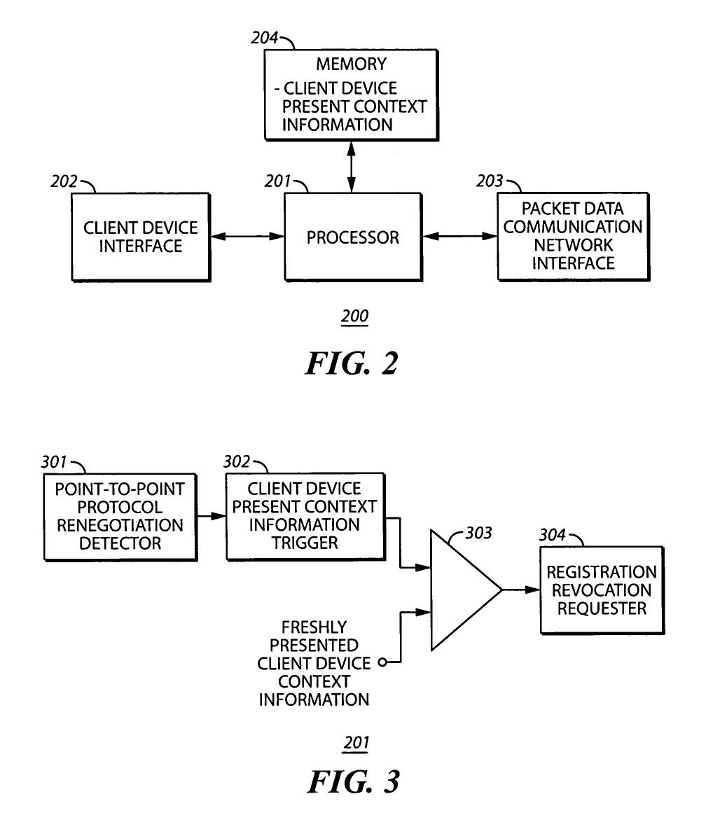

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

An exemplary network element 200 (as may be realized via, for example, a Packet Data Serving Node), in addition to such other functionality as may be desired and/or appropriate given the needs and requirements of a given application setting, may comprise a processor 201 that operably couples to a client device interface 202 (to facilitate interaction with a client device as described herein), a packet data communication network interface 203 (to facilitate interaction with other network elements as described herein such as, but not limited to, one or more Home Agents), and a memory 204 that contains, in a preferred embodiment, client device present context information as per these teachings. For example, the client device present context information can comprise information such as a Home Internet Protocol address, a Home Agent address, or the like as described herein.

In a preferred approach the processor 201 is configured and arranged, via suitable programming as will be understood by those skilled in the art, to facilitate detection of a renegotiation process, to access (and/or store and access) previous session context information, to compare the latter against freshly presented context information, and to request or squelch requesting registration revocation as taught herein. To facilitate such actions, and referring now to FIG. 3, the processor 201 can be configured and arranged to comprise a Point-to-Point Protocol renegotiation detector 301 that is responsive to Point-to-Point Protocol renegotiation as corresponds to a client device and a client device present context information trigger 302 that is responsive to the Point-to-Point Protocol renegotiation detector 301. The client device present context information trigger 302 preferably serves to at least access (or to store and access) present (i.e., previously negotiated) context information for the client device that is presently seeking to renegotiate its context.

The client device present context information trigger 302 in turn preferably couples to an input of a comparator 303. A remaining input of the comparator 303 further operably couples to receive freshly presented client device context information (as is provided by the client device pursuant to the renegotiation process) and provides a corresponding context information comparison output (representing, for example, similarities or differences as between corresponding categories of context information for these two inputs).

The output of the comparator 304 in turn operably couples to a registration revocation requester 304 that is responsive thereto and that serves to automatically not request revocation of a previous registration as corresponds to the client device when the context information comparison output corresponds to at least a first category of result such as a substantial match. In a preferred approach this registration revocation requester 304 further serves to automatically request revocation of the previous registration as corresponds to the client device when the context information comparison output corresponds to at least a second category of result such as a substantial mis-match.

Those skilled in the art will understand that an enabling platform can be discretely configured and architected as suggested by the depictions presented in FIGS. 2 and 3. Or, if desired, these illustrations can be viewed as logical presentations that represent the full or partial programming of a programmable enabling platform. Such architectural options are well understood in the art and require no further elaboration here.

To further aid in explaining and illustrating the substance and benefits of these teachings, a number of more specific examples will now be presented.

### EXAMPLE 1

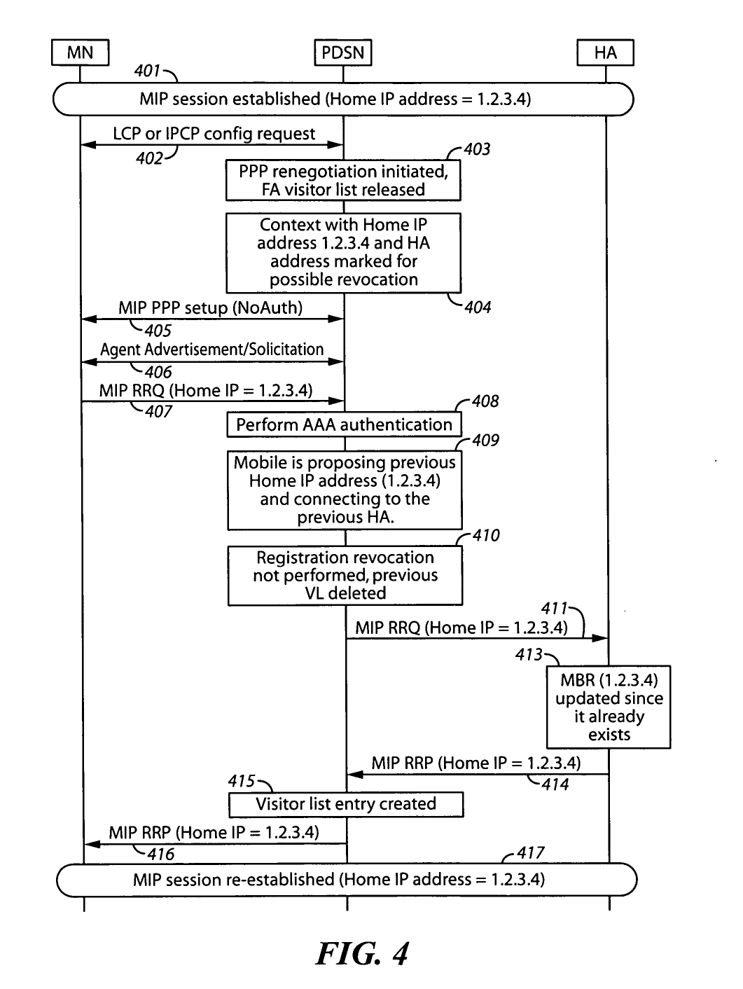

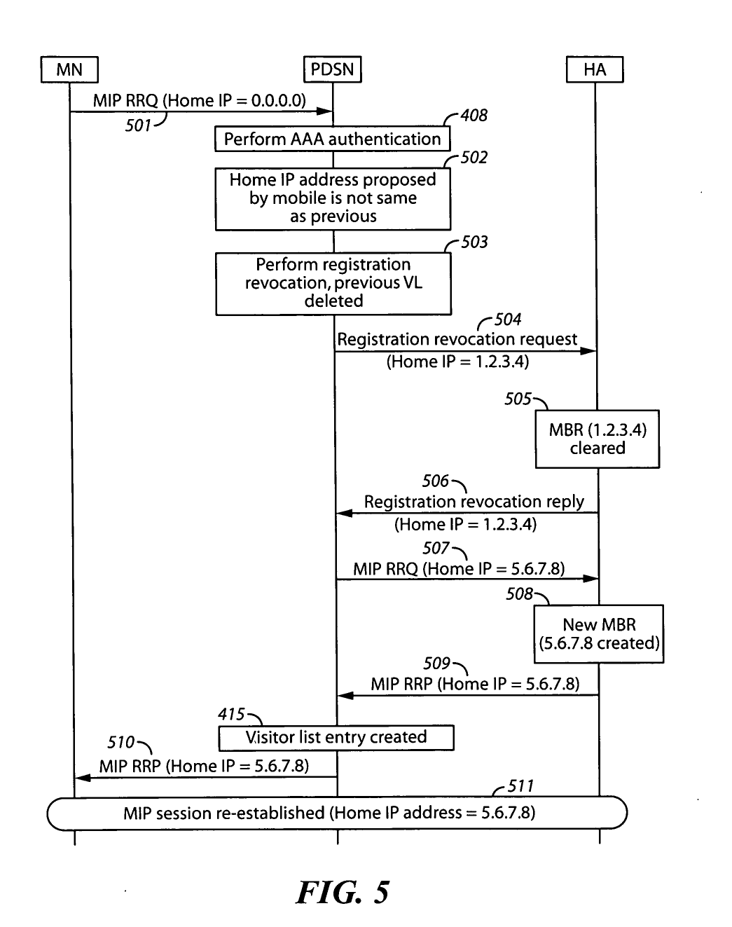

Referring now to FIG. 4, an example of a successful Point-to-Point Protocol renegotiation within the context of a same Mobile Internet Protocol context will be presented. This example begins with an already-established Mobile Internet Protocol session 401. The context for this session includes a Home Internet Protocol address of 1.2.3.4. For any number of reasons, the mobile node (MN) finds it necessary to initiate a configuration request 402 (comprising, for example, a Link Control Protocol configuration request or an Internet Protocol Control Protocol configuration request).

The Packet Data Serving Node (PDSN) initiates Point-to-Point Protocol renegotiation and releases a corresponding Foreign Agent visitor list 403. In this embodiment, the Packet Data Serving Node then stores the previous context information. In particular, the Packet Data Serving Node marks the Home Internet Protocol address (i.e., 1.2.3.4) and the previously presented Home Agent address for possible revocation 404.

The renegotiation process in this example then proceeds with a number of presently existing steps. In particular, the mobile node and Packet Data Serving Node process a Point-to-Point Protocol setup 405 and agent advertisement/solicitation 406 following which the mobile node presents a Mobile Internet Protocol registration request 407 containing a fresh Home Internet Protocol comprising, in this example, 1.2.3.4. The Packet Data Serving Node performs authentication 408 (typically via an interface with an Authorization, Authentication, and Accounting server) and then, as per these teachings, determines 409 that the mobile node is freshly presenting context information that matches the previous context. In particular, the Home Internet Address was, and is still, 1.2.3.4 and the Home Agent address indicates that the mobile node is seeking to be connected to the same Home Agent to which it was previously connected.

Given this match and as per these teachings, the Packet Data Serving Node then does not perform a registration revocation 410 and further, in this example, deletes the previous Foreign Agent visitor list (VL).

The Packet Data Serving Node then transmits a Mobile Internet Protocol registration request 411 to the corresponding Home Agent. The Mobility Binding Record (MBR) is then updated by the home agent as it already exists 413. The Home Agent then responds with a Mobile Internet Protocol registration reply 414. The Packet Data Serving Node then creates a corresponding visitor list entry 415 and communicates to the mobile node a Mobile Internet Protocol registration reply 416 and the Mobile Internet Protocol session is accordingly re-established 417.

### EXAMPLE 2

This example begins as already described above in Example 1. In this example, however, the mobile node presents a new Mobile Internet Protocol context. In particular, when the mobile node presents a Mobile Internet Protocol registration request, that request presents fresh, and different, Home Internet Protocol address information (i.e., 0.0.0.0) 501. Following authentication 408 as before, the Packet Data Serving Node in this example determines and notes this difference in context 502. Because the previous context information does not match the freshly presented context information, the Packet Data Serving Node performs registration revocation 503 and transmits a registration revocation request (for the previous Home Internet Protocol address 1.2.3.4) 504 to the Home Agent.

The Home Agent clears the MBR as corresponds to the 1.2.3.4 address 505 and replies with a registration revocation reply 506 to the Packet Data Serving Node. This is followed with a Mobile Internet Protocol registration request for the fresh Home Internet Protocol address (5.6.7.8) 507. The Home Agent then creates a new corresponding MBR 508 and responds with a Mobile Internet Protocol registration reply 509. The Packet Data Serving Node again creates the corresponding visitor list entry 415 and transmits a Mobile Internet Protocol registration reply 510 to the mobile node. The mobile node then carries forward using the re-established Mobile Internet Protocol session 511 that uses the freshly presented 5.6.7.8 Home Internet Protocol address.

Those skilled in the art will understand that the exact ordering of the revocation and the new registration is not especially important. These events can happen at any time relative to one another, or even at the same time. Accordingly, it will be understood that the specific examples presented above (and below) are illustrative in nature and do not, and are not intended, to present an exhaustive detailing of all relevant possibilities in this regard.

### EXAMPLE 3

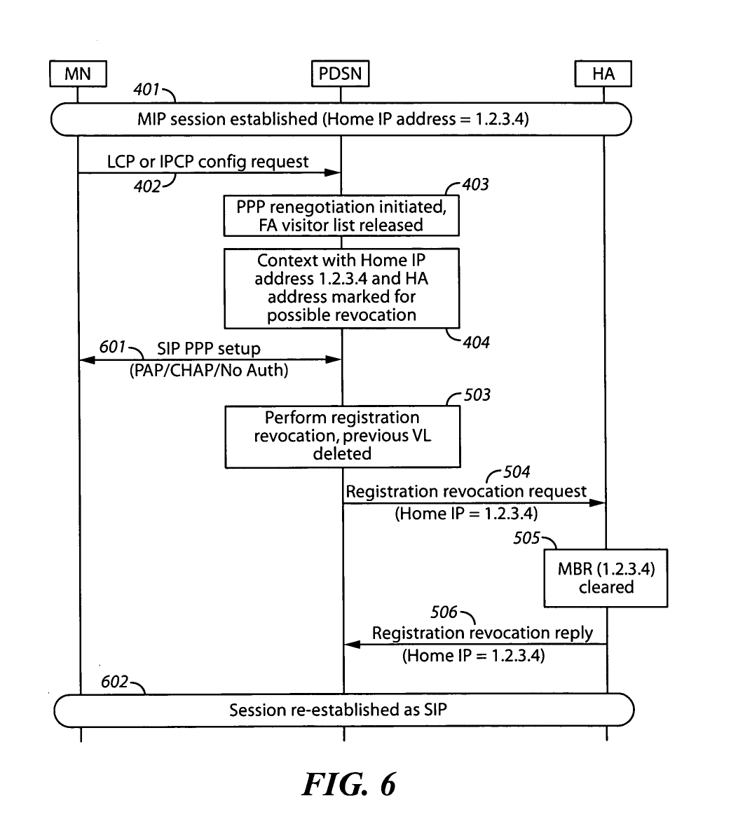

In this next example, a Mobile Internet Protocol session is re-established as a Session Initiation Protocol (SIP) session. Referring to FIG. 6, and again presuming an already-established Mobile Internet Protocol session 401, when a mobile node again presents a configuration request 402 the Packet Data Serving Node initiates Point-to-Point Protocol renegotiation 403 and stores (in this example) 404 the corresponding context information to thereby mark it for possible revocation.

In this example, however, the mobile node next conducts a non-Mobile Internet Protocol (referred to herein as Simple Internet Protocol (SIP)) Point-to-Point Protocol setup 601. In such a case, the Packet Data Serving Node can again perform registration revocation 503 (as the requisite match as per these teachings cannot occur) and a registration revocation request for the previous context 504 is transmitted to the Home Agent. The latter clears the corresponding MBR 505 and replies with a registration revocation reply 506. The session is then re-established as a Simple Internet Protocol session 602.

### EXAMPLE 4

This last example illustrates a scenario where Point-to-Point Protocol renegotiation is followed by subsequent Point-to-Point Protocol failure.

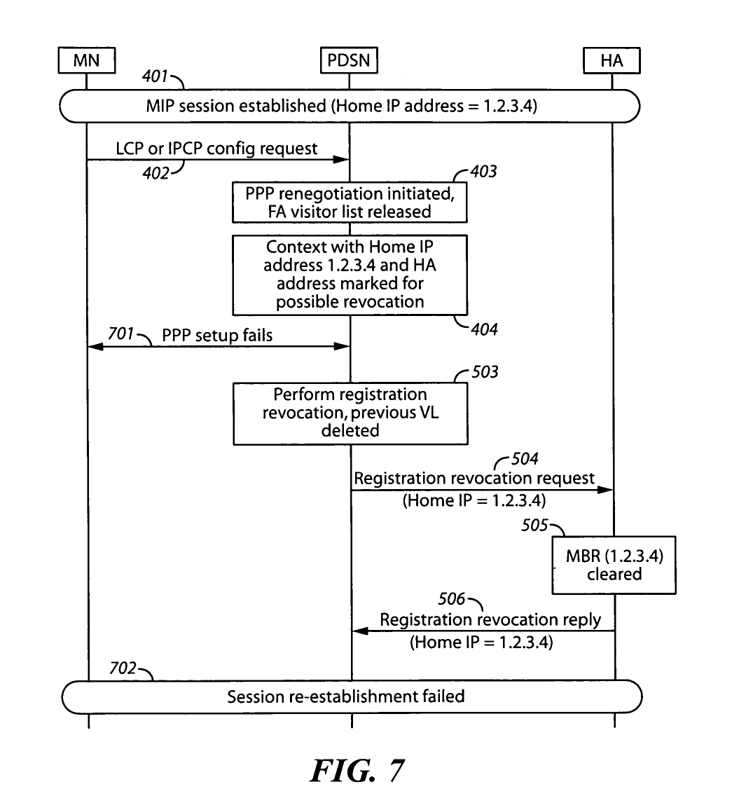

Referring to FIG. 7 the call flow proceeds as first described above in Example 1. Following the storage/access/marking step 404, however, in this example, the Point-to-Point Protocol setup fails 701. (Such fails can and do occur for any number of reasons as will be understood by those skilled in the art.) Under these circumstances, the Packet Data Serving Node can perform registration revocation 503 as is otherwise described above to clear the previously established session context. The flow then concludes with session re-establishment failure 702.

Those skilled in the art will now see and appreciate that these teachings either permit a more efficient use of system resources coupled with reduced latency or, at worst, yield performance results that are at least equal to present practices (depending upon the particular scenario in play). If desired, only a single network element (or single hierarchical layer) need be modified within a given network to receive these benefits. In particular, there is no particular need to modify an existing legacy base of mobile nodes.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a network element as comprises a part of a packet-based communication network:
detecting Point-to-Point Protocol renegotiation as corresponds to a client node;
in response to detecting the Point-to-Point Protocol renegotiation, automatically accessing context information as pertains to a previous Point-to-Point Protocol session to provide accessed context information;
facilitating the Point-to-Point Protocol renegotiation with the client node;
determining freshly presented context information as corresponds to the client node;
comparing at least some of the freshly presented context information with the accessed context information to provide a comparison result;
when the comparison result corresponds to a least a first category of result, automatically processing a registration as corresponds to the client node without also requesting revocation of a previously established registration state for the client node.

2. The method of claim 1 wherein detecting Point-to-Point Protocol renegotiation comprises processing at least one of a Link Control Protocol configuration request and an Internet Protocol Control Protocol configuration request.

3. The method of claim 1 wherein automatically accessing context information as pertains to a previous Point-to-Point Protocol session comprises automatically storing at least one of:
a Home Internet Protocol address;
a Home Agent address.

4. The method of claim 1 wherein automatically accessing context information as pertains to a previous Point-to-Point Protocol session comprises automatically storing a Home Internet Protocol address as corresponds to the client node and a Home Agent address.

5. The method of claim 1 wherein determining freshly presented context information as corresponds to the client node comprises determining at least one of a Home Internet Protocol address and a Home Agent address as corresponds to the client node.

6. The method of claim 1 wherein determining freshly presented context information as corresponds to the client node comprises determining each of a Home Internet Protocol address and a Home Agent address as corresponds to the client node.

7. The method of claim 1 wherein the first category of result comprises a match between corresponding categories of information.

8. The method of claim 1 further comprising:
when the comparison result corresponds to a least a second category of result, which second category of result is different from the first category of result, automatically processing a registration as corresponds to the client node, at least in part, by requesting revocation of a previously established registration state for the client node.

9. The method of claim 8 wherein:
the first category of result comprises a match between corresponding categories of information;
the second category of result comprises a mis-match for at least one entry for each of the accessed context information and the freshly presented context information for at least one corresponding category of information.

10. A network element comprising:
a client device interface;
a packet data communication network interface;
a client device present context information memory;
a processor operably coupled to the context information memory, the client device interface, and the packet data communication network interface, comprising:
a Point-to-Point Protocol renegotiation detector responsive to Point-to-Point Protocol renegotiation as corresponds to a client device;
a client device present context information access trigger that is responsive to the Point-to-Point Protocol renegotiation detector;
a comparator having an input operably coupled to receive accessed client device present context information and freshly presented client device context information and having a context information comparison output;
a registration revocation requester that is operably responsive to the context information comparison output.

11. The network element of claim 10 wherein the network element comprises a Packet Data Serving Node.

12. The network element of claim 10 wherein the client device present context information comprises at least one of:
a Home Internet Protocol address;
a Home Agent address.

13. The network element of claim 10 wherein the client device present context information comprises both of a Home Internet Protocol address and a Home Agent address.

14. The network element of claim 10 wherein the registration revocation requester comprises means for automatically not requesting revocation of a previous registration as corresponds to the client device when the context information comparison output corresponds to at least a first category of result.

15. The network element of claim 14 wherein the first category of result comprises a match between corresponding categories of context information.

16. The network element of claim 15 wherein the registration revocation requester further comprises means for automatically requesting revocation of the previous registration as corresponds to the client device when the context information comparison output corresponds to a least a second category of result, which second category of result is different than the first category of result.

17. The network element of claim 16 wherein the second category of result comprises a mis-match between corresponding categories of context information.

18. A network element comprising:
means for detecting Point-to-Point Protocol renegotiation as corresponds to a client node;
means responsive to the means for detecting Point-to-Point Protocol renegotiation for automatically accessing context information as pertains to a previous Point-to-Point Protocol session as corresponds to the client node to provide accessed context information;
means for facilitating the Point-to-Point Protocol renegotiation with the client node;
means for determining freshly presented context information as corresponds to the client node;
means for automatically comparing at least some of the freshly presented context information with the accessed context information to provide a comparison result;
means for automatically processing a registration as corresponds to the client node without also requesting revocation of a previously established registration state for the client node when the comparison result corresponds to a least a first category of result.

19. The network element of claim 18 further comprising:
means for automatically processing a registration as corresponds to the client node, at least in part, by requesting revocation of a previously established registration state for the client node when the comparison result corresponds to a least a second category of result, which second category of result is different from the first category of result.
